(19) United States
(12) Patent Application Publication
(10) Pub. No.: US 2021/0104877 A1
(43) Pub. Date: Apr. 8, 2021

(54) WIRING APPARATUS FOR COMMUNICATION PIPE

(71) Applicant: NANJING LONGMA COMMUNICATION ENGINEERING CO., LTD., Jiangsu (CN)

(72) Inventors: Fenghua ZHANG, Jiangsu (CN); Zhuchen ZHANG, Jiangsu (CN)

(73) Assignee: NANJING LONGMA COMMUNICATION ENGINEERING CO., LTD., Jiangsu (CN)

(21) Appl. No.: 17/123,153

(22) Filed: Dec. 16, 2020

Related U.S. Application Data
(63) Continuation of application No. PCT/CN2019/082584, filed on Apr. 13, 2019.

(30) Foreign Application Priority Data
Jun. 25, 2018 (CN) 201810664872.6

(51) Int. Cl. H02G 1/08

(52) U.S. Cl. CPC H02G 1/088

(57) ABSTRACT

A wiring apparatus for a communication pipeline includes a frame and wheels arranged on the frame in pairs. A control motor for driving the wheels to rotate is arranged on the frame, at least one pair of wheels are rotatably connected to the frame, a recessed wire clamping cavity is arranged on an outer peripheral of the wheel, a channel configured for clamping an optical power cable is formed between two wheels arranged in pairs through the wire clamping cavity, and a hook (on which a wiring can be hung) is arranged at an end of the frame.

### CROSS-REFERENCE TO RELATED APPLICATION

The present application is a continuation of international application of PCT application serial No. PCT/CN2019/082584 filed on Apr. 13, 2019, which claims the priority benefit of China application no. 201810664872.6 filed on Jun. 25, 2018. The entirety of each of the above-mentioned patent applications is incorporated herein by reference and made a part of this specification.

### BACKGROUND

### Technical Field

The present application relates to the field of communication line engineering, and more particularly, to a wiring apparatus for a communication pipe.

### Description of Related Art

Currently, optical cable laying is an important link in communication system construction.

Currently, Chinese publication number CN 107086502A discloses a communication pipeline wiring applicator, including a body, a circular arc guide block arranged at one end of the body, a motor arranged at one end of the body facing away from the circular arc guide block, an impeller arranged on a rotation shaft of the motor for pushing the body forward, and an optical power cable wiring guiding element arranged on the motor for pulling the optical power cable. The body is in a cylindrical shape, and the circular arc guide block, the body and the motor are coaxially arranged. One end of the circular arc guide block facing away from the circular arc is rotatably connected to the body, and one end of the motor facing away from the impeller is also rotatably connected to the body. A plurality of inclined rods are fixedly connected to a side surface of the body, one end of the inclined rod facing away from the body is arranged with a guide wheel, one end of the circular arc guide block facing away from the body is also arranged with a monitoring device for viewing the inside of the pipeline. Such a communication pipeline wiring applicator is of small mass and convenient to carry and operate.

When the pipeline having optical power cables therein is wired, the applicator will interfere with the optical power cables in the pipeline, and cannot operate normally. Therefore, the applicator described above is only suitable for wiring in a new pipeline.

### SUMMARY

In a first aspect, one object of the present application is to provide a wiring apparatus for a communication pipeline, which has the advantage of wiring in a pipeline having optical power cables therein.

The above technical object of the present application is achieved by the following technical solutions. A wiring apparatus for a communication pipeline is provided, which includes a frame, a hook arranged at an end of the frame, and at least one pair of wheels arranged in the middle of the frame. The at least one pair of wheels are rotatably connected to the frame, an outer peripheral of each of the at least one pair of wheels is provided with a recessed wire clamping cavity. The recessed wire clamping cavities are opposite to each other to form a channel configured for clamping an optical power cable and passing the optical power cable therethrough. A motor for driving the at least one pair of wheels to rotate is arranged on the frame.

By adopting the above technical solution, when used, the present apparatus is placed in a pipe, and the original optical power cables in the pipeline are embedded in a channel between two wheels arranged in pairs, a wire clamping cavity on the two wheels is adapted to an outer wall of the optical power cable, and the two wheels clamp the optical power cables. The motor starts, the wheel rolls in the direction of the original optical power cable in the pipeline, and the hook is configured for connecting with a new optical power cable. The new optical power cable follows the movement of the frame in the direction of the original optical power cable. By means of providing wheels and the channel, the frame moves in a pipeline by taking the original optical power cable as a guide rail, ensuring that the new optical power cable is parallel to the optical power cable and improving the passing effect of the wiring, and the wiring apparatus is easier to use.

Preferably, the frame includes two horizontal support rods, the at least one pair of wheels are symmetrically arranged on the two support rods, and a plurality of compression springs are arranged between the two support rods.

By adopting the above technical solution, when a plurality of optical power cables are arranged in the pipeline, the total diameter of the optical power cables increases, the compression spring is stretched, and the distance between the two support rods increases. By means of providing the compression spring, the distance between the two support rods can be adjusted, so that wirings can be arranged in pipelines provided with optical power cables of different sizes, and the use range is wide. Furthermore, the arrangement of the compression spring always applies pressure to the support rod, so that the wheel always clamps the optical power cables, thereby preventing the optical power cables from being removed from the channel.

Preferably, a retainer rod perpendicular to the support rods is arranged between the two support rods. The retainer rod is formed with a retainer slot parallel to the retainer rod. A sliding rod slidably connected to the retainer slot is fixed on the support rod.

By adopting the above technical solution, when the distance between the two support rods changes, the sliding rod slides in the retainer rod, and the arrangement of the retainer rod and the sliding rod guides and limits the movement path of the support rod, so as to prevent the movement paths of the two support rods from deviating, and affect the wiring of the new optical power cable.

Preferably, the at least one pair of wheels are rotatably connected to the support rods, each of the at least one pair of wheels is connected to each of the support rods via a rotation shaft, the rotation shaft is perpendicular to the support rod. The at least one pair of wheels include a driving wheel and a driven wheel. An end of the rotation shaft connected to the driving wheel passes through the support rod. The motor is arranged at a side of the support rod, an output shaft of the motor is coaxially fixed with a control worm. An end of the rotation shaft connected to the driving wheel is coaxially fixed with a control worm wheel mating with the control worm.

By adopting the above technical solution, the motor starts, the control worm drives the control worm wheel to rotate, the rotation shaft rotates to drive the driving wheel to rotate. The motor drives the wheel to rotate through the control worm wheel and the control worm, and control is stable. The wheels are arranged above the support rods, and the motor is arranged at a side of the support rod. Since the motor and the wheel are arranged on the two sides of the support rod respectively, the motor does not interfere with placement of the optical power cable, thereby facilitating the clamping of the optical power cable.

Preferably, a plurality of adjustment slots are arranged in pairs on the two support rods. An adjustment rack is slidably connected in the adjustment slot. An adjustment gear meshed with the adjustment rack is rotatably connected in the support rod. An adjustment shaft perpendicular to the support rod is rotatably connected on the support rod. The adjustment shaft is connected with the adjustment gear. Two ends of the compression spring are respectively connected with two adjustment rack arranged in pairs.

By adopting the above technical solution, the adjustment shaft is rotated to drive the adjustment rack to slide in the adjustment slot through the adjustment gear, the length of the compression spring is changed, and therefore the elastic force of the compression spring is changed, so that optical power cables of different sizes can be clamped, and the clamping effect can be guaranteed.

Preferably, the adjustment shaft is a worm, the adjustment gear is coaxially connected with an adjustment worm wheel, and the adjustment shaft meshes with the adjustment worm wheel.

By adopting the above technical solution, the adjustment shaft rotates to drive the driving wheel to rotate through the adjustment worm wheel, both the worm wheel and the worm are self-locking, which can prevent the adjustment gear from rotating, thereby affecting the adjusting effect of the compression spring.

Preferably, two sides of the two support rods facing away from the guide wheels are provided with a semi-ellipsoidal shield shell. The plurality of guide wheels are rotatably connected to the shield shell.

By adopting the above technical solution, steps can be formed at the joints of the pipelines, when the frame moves forward, ends of the support rod easily abuts against the step, thereby get stuck in the pipeline. The shield shell protects and guides the ends of the frame. When the frame moves to the joint of the pipelines, the step abuts against the surface of the shield shell. The surface of the shield shell is arc-shaped and does not abut against the step, and the frame can move normally, so that the frame is prevented from getting stuck in a pipeline. The frame moves in the pipeline, and the guide wheel abuts against the inner wall of the pipeline to roll, thereby reducing the friction force between the shield shell and the inner wall of the pipeline, facilitating the movement of the frame.

Preferably, two ends of the frame are provided with spiral-shaped wire arranging rings, two ends of the wire arranging rings, facing away from the guide wheels, are staggered upward to form an opening, and an axis of the wire arranging ring and a centerline of the channel are collinear.

By adopting the above technical solution, the photo power cable is embedded in the wire arranging ring from the opening at the upper end of the wire arranging ring. The frame is located between two wire arranging rings, during the movement of the frame, the wire arranging ring straightens the photo power cable on front of the frame, facilitating the movement of the frame, preventing the photo power cable from attaching to the pipeline, and affecting the movement of the frame.

Preferably, the wire arranging rings are respectively provided with a plurality of balls by passing the balls through.

By adopting the above technical solution, the photo power cable passes through the wire arranging ring, and when the photo power cable slides in the wire arranging ring, the photo power cable rubs against the ball. The friction between the ball and the photo power is a rolling friction, and the frictional force is small, facilitating the operation of the apparatus.

Preferably, the wire arranging ring includes two arc-shaped wire organizers, an end of one wire organizer is hinged to an end of the other wire organizer, and a reset tension spring is connected between the two wire organizers.

By adopting the above technical solution, the apparatus moves along the photo power cable, when the photo power cable is knotted, the wire organizers are opened so as to cross over the knotted position and are reset under the action of the reset tension spring. The wire organizers can stretch to open and thus avoid the knotted position in the photo power cable, thereby preventing from getting stuck during operation.

In summary, the present application has the following beneficial effects.

1. By means of providing wheels and the channel, the frame moves in a pipeline by taking the original optical power cable as a guide rail, ensuring that the new optical power cable is parallel to the original optical power cable and improving the passing effect of the wiring, and the wiring apparatus is easier to use.

2. By means of providing the compression spring, the distance between the two support rods can be adjusted, so that wiring can be performed in pipelines provided with optical power cables of different sizes, and the use range is relatively wide.

3. By means of providing the shield shell and the guide wheel, the shield shell and the guide wheels guide and protect the frame, preventing the frame from getting stuck in a pipeline. Meanwhile, when the frame inclines in the pipeline, the spherical surface of the shield shell can abut against the inner wall of the pipeline, and therefore the frame is prevented from being turned over.

### BRIEF DESCRIPTION OF THE DRAWINGS

FIG. 1 is a schematic structural diagram of a wiring apparatus for a communication pipeline according to an embodiment;

FIG. 2 is a schematic structural diagram of the wiring apparatus for a communication pipeline with a shield shell removed according to an embodiment;

FIG. 3 is an enlarged schematic diagram of part A in FIG. 1;

FIG. 4 is a schematic diagram of a connection between a spring and a support rod according to an embodiment; and

FIG. 5 is an enlarged schematic diagram of part B in FIG. 2.

### DESCRIPTION OF THE EMBODIMENTS

Hereinafter, the present application is further illustrated in detail in combination with the accompanying drawings.

### Embodiment

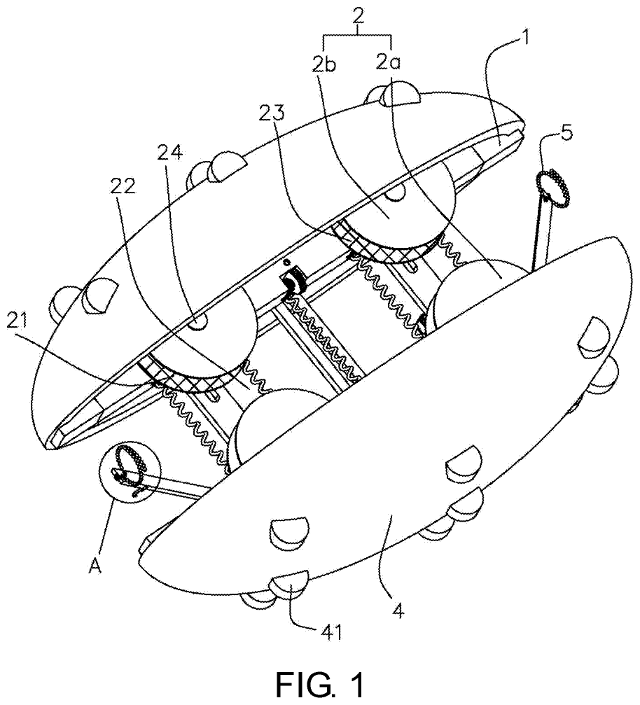

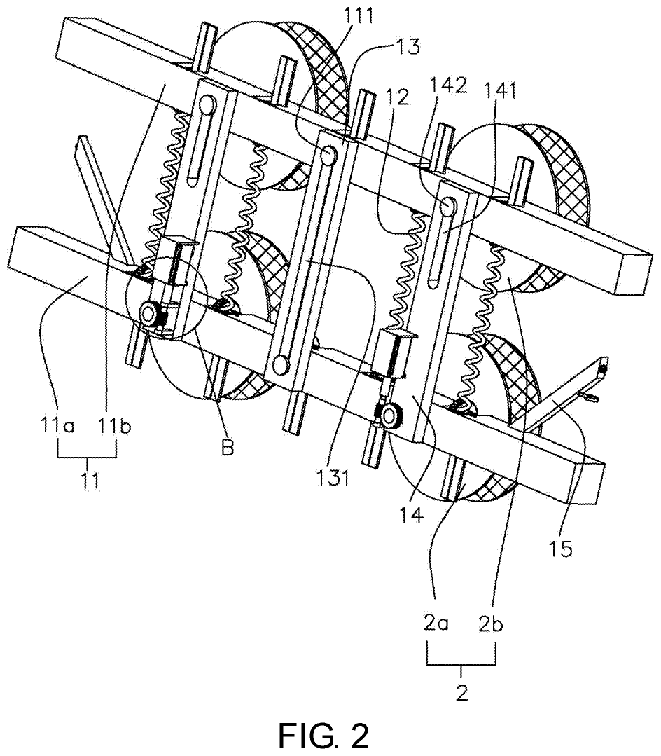

As shown in FIG. 1 and FIG. 2, a wiring apparatus for a communication pipeline is provided, which includes a frame 1, and a hook 7 arranged at the tail end of the frame 1. The frame 1 includes two support rods 11 parallel with each other, and a retainer rod 13 arranged between the two support rods 11. A total of two pairs of wheels 2 are arranged near the four ends of the two support rods 11, and the diameter of the wheels 2 is greater than the width of the support rods 11. The optical power cable can be arranged between two wheels 2 in a penetrating manner, and a channel 22 formed between two wheels 2 is configured for clamping the optical power cable. The wheel 2 rolls and moves in the pipeline along the direction of the optical power cable.

As shown in FIG. 1, a recessed wire clamping cavity 21 is arranged on an outer peripheral of each of the wheels 2, and the wire clamping cavity 21 is configured to be U-shaped and is attached to the outer wall of the optical power cable. A channel 22 configured for clamping the optical power cable is formed between two wheels 2 arranged in pairs through the wire clamping cavity 21. The optical power cable is located in the channel 22, and the inner wall of the wire clamping cavity 21 is attached to the outer wall of the optical power cable, for fixing the optical power cable and having a good fixing effect.

As shown in FIG. 1, a knurling 23 is provided in the wire clamping cavity 21 to increase the frictional force between the wire clamping cavity 21 and the optical power cable, ensuring the clamping effect and preventing slipping.

As shown in FIG. 1, two sides of the two support rods 11 are provided with semi-ellipsoidal shield shells 4, nine guide wheels 41 are rotatably connected to the shield shells 4, and the guide wheels 41 are arranged on the outer walls of the shield shells 4 in a 3*3 mode. Steps can be formed at the joints of the pipelines, when the frame 1 moves forward, the shield shell 4 protects and guides the ends of the frame 1. When the frame 1 moves to the joint of the pipelines, the step abuts against the surface of the shield shell 4. The surface of the shield shell 4 is arc-shaped and does not abut against the step, and the frame 1 can move normally, so that the frame 1 is prevented from getting stuck in a pipeline. The shield shell 4 and the guide wheels 41 guide and protect the frame 1, preventing the frame 1 from getting stuck in a pipeline. Meanwhile, when the frame 1 inclines in the pipeline, the spherical surface of the shield shell 4 can abut against the inner wall of the pipeline, and therefore the frame 1 is prevented from being turned over.

As shown in FIG. 1, two ends of the frame 1 are fixed with spiral-shaped wire arranging rings 5, and an axis of the wire arranging ring 5 and a centerline of the channel 22 are collinear. The wire arranging ring 5 is a split ring, and two ends of the wire arranging rings 5, facing away from the guide wheels 41, are staggered upward to form an opening 51. When an operator places the optical power cable, the optical power cable is rotated by 90 degrees to be perpendicular to the axis of the wire arranging ring 5 but right opposite to the opening 51 of the wire arranging ring 5, the optical power cable is embedded into the wire arranging ring 5 from the opening 51 above the wire arranging ring 5, then the optical power cable is reset, and the optical power cable is parallel to the axis of the wire arranging ring 5. The wire arranging ring 5 is simple in structure and convenient to use.

As shown in FIG. 1, the optical power cable is pre-arranged by the wire arranging ring 5. During traveling of the frame 1, the optical power cable is always located in the channel 22. In order to prevent the optical power cable before movement from attaching to the pipeline, and it is difficult for the frame 1 to smoothly enter the channel 22, during the movement of the frame 1, the wire arranging ring 5 firstly lifts the optical power cable on the front so that the optical power cable on the front is separated from the inner wall of the pipeline and is collinear with the channel 22, thereby facilitating the clamping of the wheel 2 to the optical power cable.

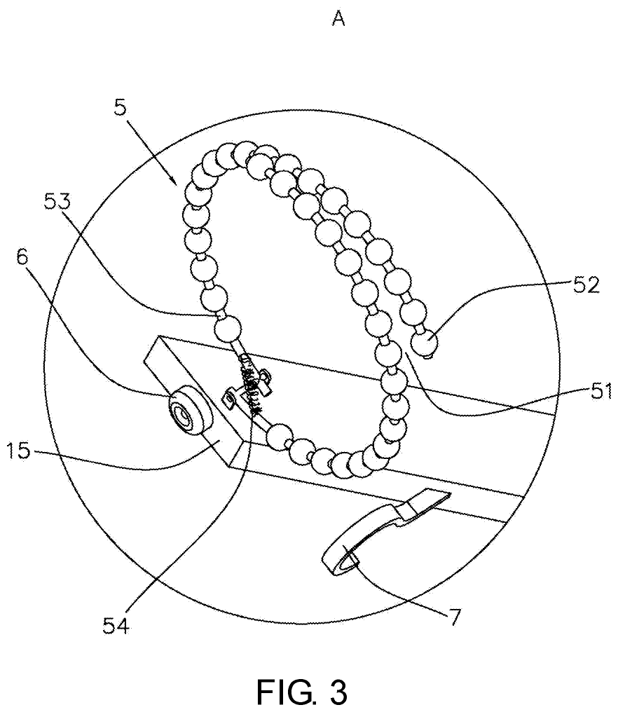

As shown in FIG. 2 and FIG. 3, the wire arranging ring 5 is connected to one of the support rods 11 via a connecting rod 15, and the wire arranging ring 5 includes two wire organizers 53. An end of one wire organizer 53 is hinged to an end of the other wire organizer, and a reset tension spring 54 is connected between the two wire organizers 53. A plurality of balls 52 passes through the wire organizers 53 to reduce the friction force between the wire organizer 53 and the optical power cable.

As shown in FIG. 2 and FIG. 3, the connecting rod 15 is provided with a camera 6. The camera 6 photographs the condition within the pipeline so that the operator can observe the condition within the pipeline.

As shown in FIG. 2, a plurality of compression springs 12 are arranged between the two support rods 11, and a retainer rod 13 is slidably connected between the two support rods 11. The distance between the two support rods 11 can be adjusted, and when a plurality of optical power cables are provided in the pipeline, the total diameter of the optical power cable increases, and at this time, the compression spring 12 is stretched, and the distance between the two support rods 11 increases. The plurality of optical power cables are arranged in the pipeline, and are easily wound together in the pipeline, resulting in the diameter of the optical power cable is sometimes large and sometimes small. When the frame 1 encounters a portion of the optical power cable with a small diameter, the compression spring 12 is contracted. When a portion of the optical power cable with a large diameter is encountered, the compression spring 12 is stretched. The compression spring 12 always applies a pulling force to the support rod 11, so that the wheel 2 always abuts against the optical power cable and clamps the optical power cables.

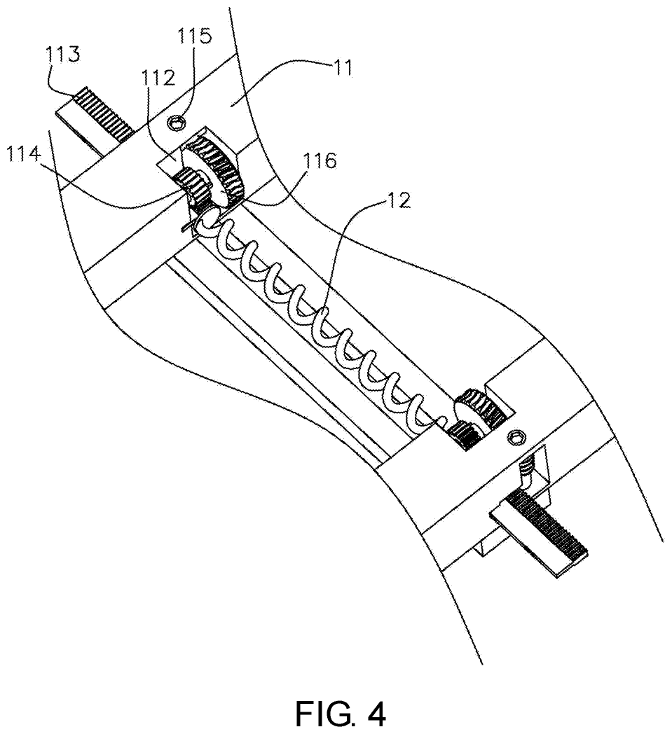

As shown in FIG. 4, a plurality of adjustment slots 112 are symmetrically arranged on the two support rods 11, an adjustment rack 113 is slidably connected in the adjustment slot 112, and an adjustment shaft 115 penetrates through the support rod 11. The adjustment shaft 115 is perpendicular and rotatably connected to the support rod 11. The adjustment shaft 115 is a worm, and the adjustment worm 116 and the adjustment gear 114 located above the adjustment rack 113 are rotatably connected in the adjustment slot 112. The adjustment shaft 115 mates with the adjustment worm wheel 116, the adjustment worm wheel 116 is coaxially fixedly connected with the adjustment gear 114, and the adjustment gear 114 meshes with the adjustment rack 113. The two ends of the compression spring 12 are respectively fixedly connected to the two adjustment racks 113. The adjustment shaft 115 rotates, and the adjustment worm wheel 116 drives the adjustment gear 114 to rotate. The adjustment rack 113 slides to pull or compress the compression spring 12, so as to adjust the elastic force of the compression spring 12, so that the compression spring 12 hoops the optical power cables of different sizes.

As shown in FIG. 2, the retainer rod 13 is slidably connected to the back surface of the support rod 11 and is perpendicular to the support rod 11. The retainer rod 13 is formed with a retainer slot 131 parallel to the retainer rod 13. A T-shaped sliding rod 111 is fixed on the back surface of the support rod 11, and a lower end of the sliding rod 111 extends out of the retainer slot 131. The compression spring 12 is stretched or contracted, the retainer rod 13 slides in the retainer slot 131, and the retainer rod 13 defines the movement path of the support rod 11, preventing from misalignment due to the movement path deviation of the two support rods 11.

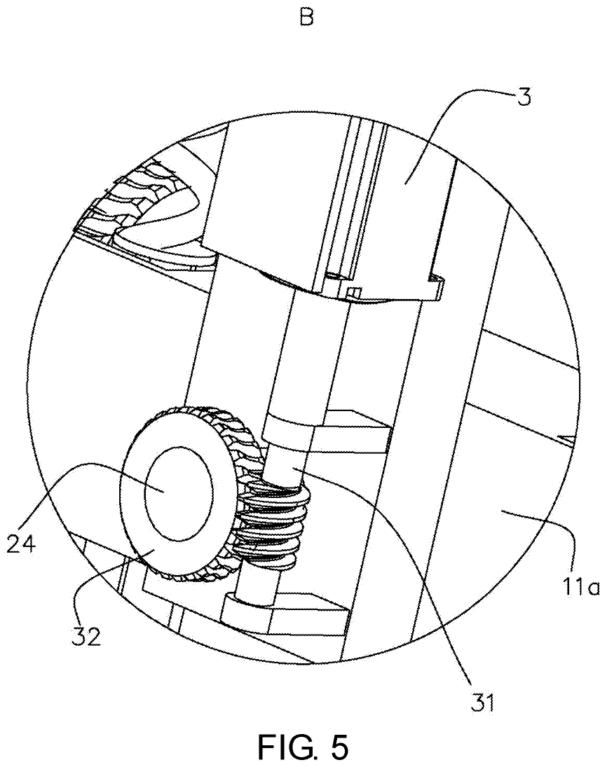

As shown in FIG. 2 and FIG. 5, the support rod 11 includes a driving rod 11a and a driven rod 11b, the wheels 2 provided at two ends of the driving rod 11a are driving wheels 2a, and the wheels 2 provided at two ends of the driven rod 11b are driven wheels 2b. The back surface of the driving rod 11a is provided with two control motors 3, which respectively control the rotation of the two driving wheels 2a. The two control motors 3 and the two driving wheels 2a provide power to the movement of the frame 1, and the driving force is stronger, thereby ensuring stable movement of the frame 1.

As shown in FIG. 2 and FIG. 5, the driving wheel 2a and the driven wheel 2b are arranged on the front surface of the support rod 11, and the motor 3 is arranged on the back surface of the support rod 11. The motor 3 and the wheel 2 are arranged on both sides of the support rod 11, preventing the motor 3 from interfering with the wheel 2, and affecting the mounting of the photo power cable.

As shown in FIG. 5, a rotation shaft 24 penetrates through the center of the driving wheel 2a (see FIG. 2), and an end of the rotation shaft 24 penetrates through the driving rod 11a and is connected to the motor 3. The end of the rotation shaft 24 is provided with a control worm wheel 32, the output shaft of the motor 3 is connected with a control worm 31, and the control worm wheel 32 and the control worm 31 mate with each other. The motor 3 starts to drive the rotation shaft 24 to rotate through the control worm 31 and the control worm wheel 32, thereby driving the driving wheel 2a to rotate.

As shown in FIG. 2 and FIG. 5, a connecting plate 14 is arranged at two ends on the back surface of the driving rod 11a, one end of the connecting plate 14 is perpendicular to and fixedly connected to the driving rod 11a, and the other end is slidably connected to the driven rod 11b. The motor 3 is fixed to the connecting plate 14, and the connecting plate 14 provides a support carrier for the motor 3 so as to facilitate the mounting of the motor 3. The end of the rotation shaft 24 passes out of the connecting plate 14 and is connected to the motor 3.

As shown in FIG. 2, a strip-shaped connecting slot 141 is formed on an end of the connecting plate 14 toward the driven rod 11b, a T-shaped connecting block 142 is fixed on a back surface of the driven rod 11b, and the connecting block 142 is embedded in the connecting slot 141.

In the specific implementation process, the optical power cable is clamped and embedded in the channel 22, the two ends of the optical power cable penetrate through the inner ring of the wire arranging ring 5, and the wheel 2 hoops the optical power cable tightly. The driving wheel 2a abuts against the inner wall of the pipeline to place the frame 1 in the pipeline. The motor 3 starts, the driving wheel 2a drives the frame 1 to move in the direction of the optical power cable, and when encountering obstacles or obstructions in the advancing process, the driving wheel 2a can retreat by a certain distance first, and then advance again until the frame 1 walks out of the pipeline. By means of forward and backward movements of the motor 3, manual operations are reduced, the passing effect of the wiring is improved, and the wiring apparatus is easier to use.

These embodiments are merely explanatory and are not restrictive of the application. After reading this specification, those skilled in the art can make various modifications to the embodiments as needed without creative work, which falls within the protection scope defined by the appended patent claims.

What is claimed is:

1. A wiring apparatus for a communication pipeline, the wiring apparatus comprising a frame, a hook arranged at an end of the frame, and at least one pair of wheels arranged in the middle of the frame, wherein:
the at least one pair of wheels are rotatably connected to the frame;
an outer peripheral of each of the at least one pair of wheels is provided with a recessed wire clamping cavity;
the recessed wire clamping cavities are opposite to each other to form a channel configured for clamping an optical power cable and passing the optical power cable therethrough; and
a motor for driving the at least one pair of wheels to rotate is arranged on the frame.

2. The wiring apparatus for a communication pipeline according to claim 1, wherein:
the frame comprises two horizontal support rods;
the at least one pair of wheels are symmetrically arranged on the two support rods; and
a plurality of compression springs are arranged between the two support rods.

3. The wiring apparatus for a communication pipeline according to claim 2, wherein:
a retainer rod perpendicular to the support rods is arranged between the two support rods; and
the retainer rod is formed with a retainer slot parallel to the retainer rod, and a sliding rod slidably connected to the retainer slot is fixed on each of the support rods.

4. The wiring apparatus for a communication pipeline according to claim 3, wherein:
the at least one pair of wheels are rotatably connected to the support rods, each of the at least one pair of wheels is connected to each of the support rods via a rotation shaft, the rotation shaft is perpendicular to the support rods;
the at least one pair of wheels comprise a driving wheel and a driven wheel, an end of the rotation shaft connected to the driving wheel passes through a corresponding one of the support rods; and
the motor is arranged at a side of the support rod, an output shaft of the motor is coaxially fixed with a control worm, and an end of the rotation shaft connected to the driving wheel is coaxially fixed with a control worm wheel mating with the control worm.

5. The wiring apparatus for a communication pipeline according to claim 2, wherein:
a plurality of adjustment slots are arranged in pairs on the two support rods, an adjustment rack is slidably connected in each of the adjustment slots, an adjustment gear meshed with the adjustment rack is rotatably connected in each of the support rods, an adjustment shaft perpendicular to the support rods is rotatably connected on each of the support rods, the adjustment shaft is connected with the adjustment gear, and two ends of the compression spring are respectively connected with two adjustment rack arranged in pairs.

6. The wiring apparatus for a communication pipeline according to claim 5, wherein:
the adjustment shaft is a worm, the adjustment gear is coaxially connected with an adjustment worm wheel, and the adjustment shaft meshes with the adjustment worm wheel.

7. The wiring apparatus for a communication pipeline according to claim 2, wherein:
two sides of the two support rods facing away from the guide wheels are provided with a semi-ellipsoidal shield shell, and a plurality of guide wheels are rotatably connected to the shield shell.

8. The wiring apparatus for a communication pipeline according to claim 1, wherein:
two ends of the frame are provided with spiral-shaped wire arranging rings, two ends of the wire arranging rings, facing away from the guide wheels, are staggered upward to form an opening, and an axis of the wire arranging ring and a centerline of the channel are collinear.

9. The wiring apparatus for a communication pipeline according to claim 8, wherein:
the wire arranging rings are respectively provided with a plurality of balls by passing the balls through.

10. The wiring apparatus for a communication pipeline according to claim 8, wherein:
the wire arranging ring comprises two arc-shaped wire organizers, an end of one wire organizer is hinged to an end of the other wire organizer, and a reset tension spring is connected between the two wire organizers.
